(19) United States
(12) Patent Application Publication
(10) Pub. No.: US 2006/0254868 A1
(43) Pub. Date: Nov. 16, 2006

(54) Motor vehicle brake system

(76) Inventors: Jochen Thiesing, Mainz Kastel (DE); Andreas Schirling, Pfungstadt (DE)

Correspondence Address: CONTINENTAL TEVES, INC., ONE CONTINENTAL DRIVE, AUBURN HILLLS, MI, 48326-1581, US

(21) Appl. No.: 10/567,301

(22) PCT Filed: Apr. 15, 2004
(86) PCT No.: PCT/EP04/50530

§ 371 Date: Feb. 6, 2006

(30) Foreign Application Priority Data
Aug. 6, 2003 (DE) 10335926.5
Oct. 21, 2003 (DE) 10348829.4

(51) Int. Cl. B60L 7/10

(52) U.S. Cl. 188/159

(57) ABSTRACT

Discloses is a motor vehicle brake having at least one brake disc or brake drum, at least two brake linings, and a device for detecting the tensioning force acting upon the brake linings when the motor vehicle is actuated. The brake linings include a carrier plate and a friction layer that is movable into engagement with the brake disc or brake drum. The device for detecting the tensioning force is designed so that it senses variations in the electric resistance (3) of the friction layer (2) that occur upon actuation of the motor vehicle brake, and evaluates them to determine the tensioning force. This allows for measurements of the tensioning forces that occur upon brake actuation with a sufficiently high rate of measuring accuracy at low costs.

### BACKGROUND OF THE INVENTION

The present invention relates to a motor vehicle brake having at least one brake disc or at least one brake drum, at least two brake linings and a device for detecting a tensioning force acting upon the brake linings when the motor vehicle brake is actuated, with the brake linings including a carrier plate and a friction layer movable into engagement with the brake disc or the brake drum.

It is very important in particular in electronically brake systems to determine the tensioning force or a quantity representative of the tensioning force. Conventional hydraulic or electrohydraulic brake systems use pressure sensors for this purpose which are associated with the individual wheel brakes and sense the pressures introduced into the wheel brakes, while the desired values of the tensioning forces are derived from the output signals of the sensors.

In electromechanical brake systems the tensioning force is usually determined by means of tensioning force sensors which are integrated into the actuators. Thus, EP 1 242 797 B1 discloses an actuator-integrated force sensor which senses the deformation or flexure of a supporting ring that bears against the bottom of an actuating element cooperating with one of the brake linings in a force-transmitting manner. EP 0 849 576 B1 discloses a capacitive force sensor which is arranged between a piston that transmits the tensioning force onto one of the brake linings and an end of a spindle which is driven by an electric motor and generates the necessary tensioning force. However, it is considered disadvantageous that comparatively high costs are incurred which are inevitably related to the use of the mentioned force sensor equipment.

### SUMMARY OF THE INVENTION

In view of the above, an object of the invention is to disclose a motor vehicle brake of the type referred to hereinabove, where the measurements of the tensioning force can be performed with a sufficiently high rate of measuring accuracy at low costs.

A first inventive solution of the object involves that the device for detecting the tensioning force is designed in such a manner that it senses variations in the electric resistance of the friction layer that occur upon actuation of the motor vehicle brake, and evaluates them to determine the tensioning force.

A second inventive solution of the object, which can be used in particular in brake systems whose brake linings include a connecting layer between the carrier plate and the friction layer, involves that the device for detecting the tensioning force is designed in such a manner that it senses variations in the electric resistance of the connecting layer that occur upon actuation of the motor vehicle brake, and evaluates them to determine the tensioning force.

In a third solution of the object referred to hereinabove, the invention arranges that the device for detecting the tensioning force is formed of a force-sensing element integrated into the friction layer, which supplies an electric signal upon actuation of the motor vehicle brake that is evaluated to determine the tensioning force.

Finally, a fourth solution of the object involves that the device for detecting the tensioning force is formed of a force-sensing element integrated into the carrier plate, which supplies an electric signal upon actuation of the motor vehicle brake that is evaluated to determine the tensioning force.

A favorable improvement of the first and the second solution provides that the detected resistance values are adjusted to a measured or calculated temperature value which is furnished from a temperature-measuring element to determine the temperature of the friction layer or the connecting layer. It is especially advantageous when the friction layer or the connecting layer is connected to an electric conditioning circuit whose output signal, along with the output signal representative of the temperature value, is sent to a microprocessor for evaluation.

In another favorable embodiment of the subject matter of the invention, means for continuously monitoring the electric resistance of the friction layer or the connecting layer at a defined temperature are provided, and the measuring values thereof are taken into account to detect aging effects and compensated by data stored in the microprocessor, if applicable.

According to another embodiment of the invention, means for sensing the wear of the friction layer are provided, and the measuring values thereof are compensated by data stored in the microprocessor.

### BRIEF DESCRIPTION OF THE DRAWINGS

The invention will be explained in detail by way of three embodiments in the subsequent description, making reference to the accompanying drawings, and parts corresponding to each other have been assigned like reference numerals.

In the drawings:

FIG. 1 is a schematic view of a bake lining which is used as a device for determining the tensioning force;

FIG. 2 is a simplified view of an electric circuit for evaluating variations in the electric resistance of the brake lining shown in FIG. 1;

FIG. 3 is a diagrammatic view of the dependency of the voltage, representative of the tensioning force to be determined, on the electric resistance of the friction layer of the illustrated brake lining;

FIG. 4 is a cross-sectional view of a second design of a brake lining that can be used as a device to determine the tensioning force; and

FIG. 5 shows a third design of a brake lining that can be used as a device to determine the tensioning force in a cross-sectional view corresponding to FIG. 4.

### DETAILED DESCRIPTION OF THE DRAWINGS

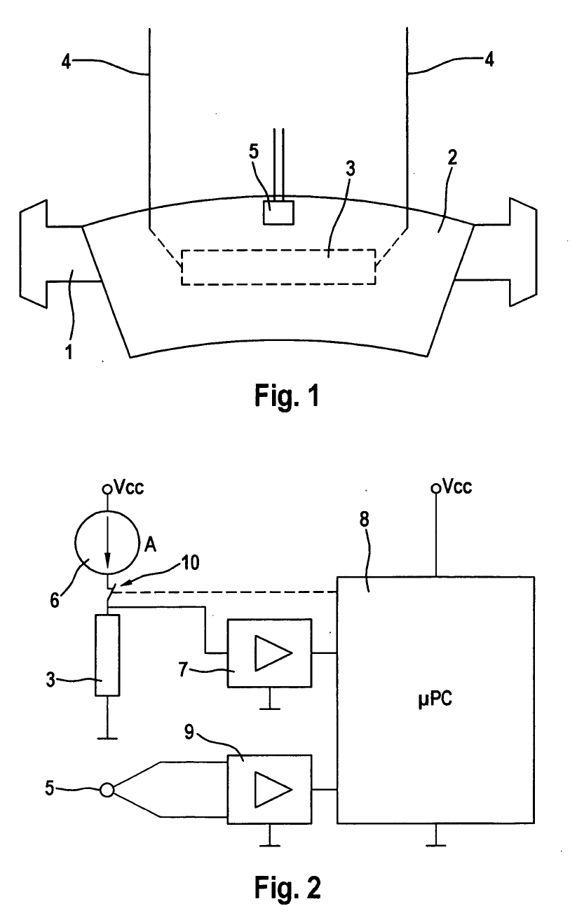

The brake lining shown in FIG. 1 comprises a metallic carrier plate 1 and a friction layer 2 which is rigidly connected to the carrier plate 1, e.g. by vulcanizing. The electric resistance of the friction lining is shown in dotted lines and designated by reference numeral 3. Two electric lines 4 used for contacting the friction layer 2 are inserted into the friction layer 2. Further, a thermoelement 5 is provided and supplies information about the temperature to the friction layer 2. When the electric resistance of the friction layer 2 changes only slightly, the thermoelement 5 is not necessary.

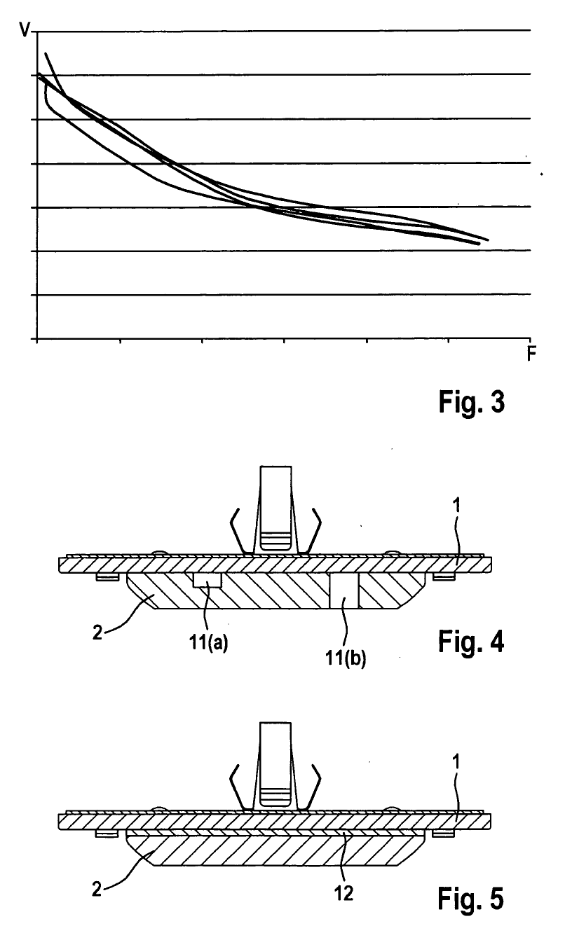

The evaluating circuit illustrated in FIG. 2 includes a constant current source 6 feeding the friction layer 2. The friction layer 2 or 3, respectively, is connected to ground, on the one hand, and to an electric conditioning circuit 7, an amplifier, if applicable, on the other hand, the output thereof being sent to a microprocessor 8. The thermoelement 5 mentioned with respect to FIG. 1 is connected to a second conditioning circuit 9 or an amplifier, respectively, the output whereof is likewise sent to the microprocessor 8. In the microprocessor 8, the output signal of the first conditioning circuit 7, which corresponds to the change in voltage caused by the effect of a force that acts on the friction layer 2, is adjusted to the output signal of the second conditioning circuit 9, and the result is an accurate, temperature-compensated value of the force that acts on the friction layer 2 or the tensioning force to be determined, respectively. The dependence of the voltage V determined by the microprocessor 8 on the tensioning force F is shown in a diagrammatic view in FIG. 3. As relatively high currents flow regarding the low resistances of conventional friction layers, the constant current source 6 is clocked by the microprocessor 8 in order to reduce the energy requirement. For this purpose, a switch 10 which can be driven by the microprocessor is provided between the constant current source 6 and the friction layer 2 or 3, respectively.

FIGS. 4 and 5 illustrate alternative embodiments of the subject matter of the invention. In the embodiment shown in FIG. 4, the device for detecting the tensioning force is formed of a force-sensing element 11 which is integrated into the friction layer 2 and designed as a non-abrasive element in the left-hand half of the illustration, while it is designed as an abrasive element in the right-hand half of the illustration. A design version (not shown) arranges for a force-sensing element to be integrated into the carrier plate. The force-sensing elements can be mounted either during manufacture of the brake lining, or retroactively.

In the embodiment shown in FIG. 5, the tensioning force is determined by measuring the variations of the electric resistance of a connecting layer 12 provided between the carrier plate 1 and the friction layer 2. It is, however also feasible to provide a connecting layer made of piezoelectric material.

1-8. (canceled)

9. A motor vehicle brake comprising:
at least one brake disc or at least one brake drum;
at least two brake linings including a carrier plate (1) and a friction layer (2) moveable into engagement with the brake disc or the brake drum; and
a device for detecting a tensioning force acting upon the brake linings when the motor vehicle brake is actuated, wherein the device for detecting the tensioning force senses variations in an electric resistance (3) of the friction layer (2) that occur upon actuation of the motor vehicle brake, and evaluates the variations to determine the tensioning force.

10. A motor vehicle brake according to claim 9, wherein the detected resistance values are adjusted to a measured or calculated temperature value which is provided from a temperature-measuring element (5) to detect the temperature of the friction layer (2) or the connecting layer (12).

11. A motor vehicle brake according to claim 10, wherein the friction layer (2) or the connecting layer (12) is connected to an electric conditioning circuit (7), and the output signal thereof, along with the output signal representative of the temperature value, is sent to a microprocessor (8) for evaluation.

12. A motor vehicle brake according to claim 9, wherein one or more devices for continuously monitoring the electric resistance of the friction layer or the connecting layer at a defined temperature are provided, and the measuring values thereof are taken into account to detect aging effects and compensated by data stored in a microprocessor.

13. A motor vehicle brake according to claim 9, wherein one or more devices for sensing the wear of the friction layer are provided, the measuring values thereof are compensated by data stored in a microprocessor.

14. A motor vehicle brake comprising:
at least one brake disc or at least one brake drum;
at least two brake linings having a carrier plate (1), a friction layer (2) movable into engagement with the brake disc or the brake drum, as well as a connecting layer (12) arranged between the carrier plate (1) and the friction layer (2); and
a device for detecting a tensioning force acting upon the brake linings when the motor vehicle brake is actuated, wherein the device for detecting the tensioning force senses variations in the electric resistance of the connecting layer (12) that occur upon actuation of the motor vehicle brake, and evaluates the variations to determine the tensioning force.

15. A motor vehicle brake according to claim 14, wherein the detected resistance values are adjusted to a measured or calculated temperature value which is provided from a temperature-measuring element (5) to detect the temperature of the friction layer (2) or the connecting layer (12).

16. A motor vehicle brake according to claim 15, wherein the friction layer (2) or the connecting layer (12) is connected to an electric conditioning circuit (7), and the output signal thereof, along with the output signal representative of the temperature value, is sent to a microprocessor (8) for evaluation.

17. A motor vehicle brake according to claim 14, wherein one or more devices for continuously monitoring the electric resistance of the friction layer or the connecting layer at a defined temperature are provided, and the measuring values thereof are taken into account to detect aging effects and compensated by data stored in a microprocessor.

18. A motor vehicle brake according to claim 14, wherein one or more devices for sensing the wear of the friction layer are provided, the measuring values thereof are compensated by data stored in a microprocessor.

19. A motor vehicle brake comprising:
at least one brake disc or at least one brake drum;
at least two brake linings having a carrier plate and a friction layer movable into engagement with the brake disc or the brake drum; and
a device for detecting a tensioning force acting upon the brake linings when the motor vehicle brake is actuated, wherein the device for detecting the tensioning force is formed of a force-sensing element (11) integrated into the friction layer, which supplies an electric signal upon actuation of the motor vehicle brake that is evaluated to determine the tensioning force.

20. A motor vehicle brake according to claim 19, wherein one or more devices for continuously monitoring the electric resistance of the friction layer or the connecting layer at a defined temperature are provided, and the measuring values thereof are taken into account to detect aging effects and compensated by data stored in a microprocessor.

21. A motor vehicle brake according to claim 19, wherein one or more devices for sensing the wear of the friction layer are provided, the measuring values thereof are compensated by data stored in a microprocessor.

22. A motor vehicle brake comprising:
at least one brake disc or at least one brake drum;
at least two brake linings having a carrier plate and a friction layer movable into engagement with the brake disc or the brake drum; and
a device for detecting a tensioning force acting upon the brake linings when the motor vehicle brake is actuated, wherein the device for detecting the tensioning force is formed of a force-sensing element integrated into the carrier plate, which supplies an electric signal upon actuation of the motor vehicle brake that is evaluated to determine the tensioning force.

23. A motor vehicle brake according to claim 22, wherein one or more devices for continuously monitoring the electric resistance of the friction layer or the connecting layer at a defined temperature are provided, and the measuring values thereof are taken into account to detect aging effects and compensated by data stored in a microprocessor.

24. A motor vehicle brake according to claim 22, wherein one or more devices for sensing the wear of the friction layer are provided, the measuring values thereof are compensated by data stored in a microprocessor.
